(19) United States
(12) Patent Application Publication
(10) Pub. No.: US 2009/0040317 A1
(43) Pub. Date: Feb. 12, 2009

(54) CAMERA MODULE HAVING IMAGE SENSOR

(76) Inventors: Dong-Youl Park, Suwon-si (KR); Young-Kwon Yoon, Seoul (KR); Yeon-Jun Lee, Suwon-si (KR)

Correspondence Address: CHA & REITER, LLC, 210 ROUTE 4 EAST STE 103, PARAMUS, NJ, 07652, US

(21) Appl. No.: 12/188,245

(22) Filed: Aug. 8, 2008

(30) Foreign Application Priority Data
Aug. 8, 2007 (KR) 2007-0079431

(51) Int. Cl. H04N 5/228; G03B 17/00

(52) U.S. Cl. 348/208.2; 396/55; 348/E05.031

(57) ABSTRACT

A camera module having an image sensor, which forms a low-pixel image sensor integrated with an image signal processing unit such as Image Signal Processor (ISP)/Analog Front End (AFE) includes: an image sensor unit for converting light being incident after passing through a prism into image data and applying image data, which is hand shake-corrected by movements between a plurality of positions, to a multimedia processor of a product, a drive controller for receiving and calculating hand-shake information acquired by a plurality of gyrosensors and calculating an amount of correction to control driving of a sensor driver, a motor, and lenses, and the sensor driver for moving the image sensor unit to correct a hand shake under control of the drive controller.

### CLAIM OF PRIORITY

This application claims the benefit of an earlier Patent Application filed in the Korean Intellectual Property Office on Aug. 8, 2007 and assigned Serial No. 2007-79431, the entire disclosure of which is hereby incorporated by reference.

### BACKGROUND OF THE INVENTION

1. Field of the Invention

The present invention relates to a camera module provided in a portable device, and more particularly to a camera module having a low-pixel (or low-resolution) image sensor integrated with an image signal processing unit.

2. Description of the Related Art

As camera modules can be mounted in portable communication apparatuses with recent advances in light weight miniaturization of digital cameras, portable communication apparatuses are commonly equipped with optical lenses for enhanced imaging.

With increasing mobility and portability of a portable communication apparatus with a camera module, an image can be blurred by minute vibration or a hand shaking of a user. In this context, there are increasing demands for correcting vibration, such as a hand shake, in order to acquire a clear image.

Although high-resolution cameras are available with the progress of the optical technology, the effect of mounting the high-resolution cameras is reduced due to image blurs caused by the shake or vibration, leading to a need for optical image stabilizers.

Current technologies for correcting images can be classified into Digital Image Stabilization (DIS), Electronic Image Stabilization (EIS), and Optical Image Stabilization (OIS).

DIS detects and corrects a hand shake using an image signal stored in a memory. More specifically, DIS detects a motion vector using an image signal stored in a memory after generated by an imaging device, and changes a read timing for the memory using the detected motion vector, thereby correcting an error caused by a hand shake.

According to DIS, the function of correcting a hand shake can be implemented in a simple way. However, the size of an image that can be read from the memory according to the changed read timing is the same as that of an effective pixel region. Thus, the read image has to be reproduced/recorded after being enlarged with digital zoom. The digital zoom, however, may cause degradation of the reproduced/recorded image.

To solve the problem of DIS, EIS has been developed.

EIS detects and corrects a hand shake using gyrosensors and a high-pixel image sensor such as Charge Coupled Diode (CCD)/Complementary Metal-Oxide Semiconductor (CMOS). FIS detects the amount and direction of hand shake using horizontal/vertical gyrosensors, then changes an output timing of the high-pixel image sensor depending on the detected amount and direction of hand shake, thereby correcting the error associated with the hand shake.

In EIS, an image formed by an image signal being output from the high-pixel image sensor according to the changed output timing has the same size as the original image. This is because the high-pixel image sensor used in EIS outputs an image, the total number of pixels of which is much greater than the number of effective pixels. Therefore, the image reproduced/recorded by EIS may not suffer degradation. However, EIS requires the gyrosensors and the high-pixel image sensor, thus increasing the manufacturing cost.

OIS detects and corrects a hand shake using gyrosensors, a prism, and a high pixel-image sensor such as CCD/CMOS. OIS also detects the amount and direction of hand shake using horizontal/vertical gyrosensors like EIS. However, OIS is different from EIS in that it uses a prism capable of changing a path of light being incident on the high-pixel image sensor in order to correct the hand shake.

A description will now be made of a camera module adopting OIS as an example.

As illustrated in FIGS. 1 and 2, a camera module 10 employing OIS includes a high-pixel image sensor 20, an image signal processing unit 30 such as ISP/AFE, horizontal/vertical gyrosensors 40, a drive controller 50, a sensor driver 60, a motor 70, a carrier 80, lenses 90, an infrared filter 92, and a Printed Circuit Board (PCB) 93. The high-pixel image sensor 20 converts light being incident along a path changed using a prism 91 into image data. The image signal processing unit 30 processes the image data being output from the high-pixel image sensor 20. The horizontal/vertical gyrosensor 40 acquires hand-shake information (the amount and direction of hand shake). The drive controller 50 calculates the hand-shake information from the gyrosensors 40 and calculates the required amount of correction. The sensor driver 60 moves the high-pixel image sensor 20 by an amount corresponding to the hand-shake information. The motor 70 performs auto-focusing and zooming.

The image signal processing unit 30 applies the hand shake-corrected image data to a multimedia processor la for display. The multimedia processor la is included in a portable communication apparatus 1. The sensor driver 60 includes a plurality of balls 61, a permanent magnet 62, and a coil 63.

However, a conventional camera module using OIS needs a high-pixel image sensor such as CCD/CMOS and a separate image signal processing unit such as ISP/AFE in order to implement a high-pixel camera module, hindering miniaturization efforts due to an increase in the number of parts, increasing the manufacturing cost, and requiring a separate space for assembly.

### SUMMARY OF THE INVENTION

An aspect of the present invention is to address at least the above problems and/or disadvantages and to provide at least the advantages described below. Accordingly, an aspect of the present invention is to provide a camera module having a low-pixel image sensor integrated with an image signal processing unit such as Image Signal Processor (ISP)/Analog Front End (AFE) instead of using a separate image signal processor such as ISP/AFE in addition to an existing high-pixel image sensor such as Charge Coupled Diode (CCD)/Complementary Metal-Oxide Semiconductor (CMOS), thereby removing a need to additionally include an image signal processing unit such as ISP/AFE in an image sensor, thus enabling product miniaturization and manufacturing cost reduction.

According to an aspect of the present invention, a camera module having an image sensor includes: an image sensor unit for converting light being incident after passing through a prism into image data and applying image data, which is hand shake-corrected by a movement between a plurality of positions, to a multimedia processor of a product, a drive controller for receiving and calculating hand-shake information acquired by a plurality of gyrosensors and calculating an amount of correction to control the driving of a sensor driver, a motor, and lenses, and the sensor driver for moving the image sensor unit to correct a hand shake under control of the drive controller.

The image sensor unit may include a low-pixel image sensor, which includes a System on Chip (SoC).

The image sensor unit may be integrated with an image signal processing unit, which includes an Image Signal Processor (ISP).

In a moving-image capturing mode, the image sensor unit may acquire hand-shake information of a hand shake with respect to a center of the lenses of the product, correct the hand shake, and output the hand shake-corrected image data in a YUV-data format to apply the image data in the YUV-data format to the multimedia processor of the product, and the multimedia processor then may process the image data and display the processed image data on a liquid crystal display unit included in the product, and in a still-image capturing mode, the sensor driver may sequentially move to four positions with respect to the image sensor unit to correct the hand shake and acquire images of a maximum resolution allowed by the image sensor unit, and the image sensor unit may convert the acquired images into image data and output the respective image data in a vector-data format, and the multimedia processor of the product may store the respective image data in a memory and then interpolate the image data to generate a high-pixel image.

Each of the four positions may correspond to ¼ of a pixel size of the image sensor.

The product may be any one of a portable communication apparatus, a digital camera, and a digital camcorder.

The image sensor unit may be used for any one of a camera module mounted in a portable communication apparatus, a digital camera, and a digital camcorder.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 is a cross-sectional view of a conventional camera module having an image sensor;

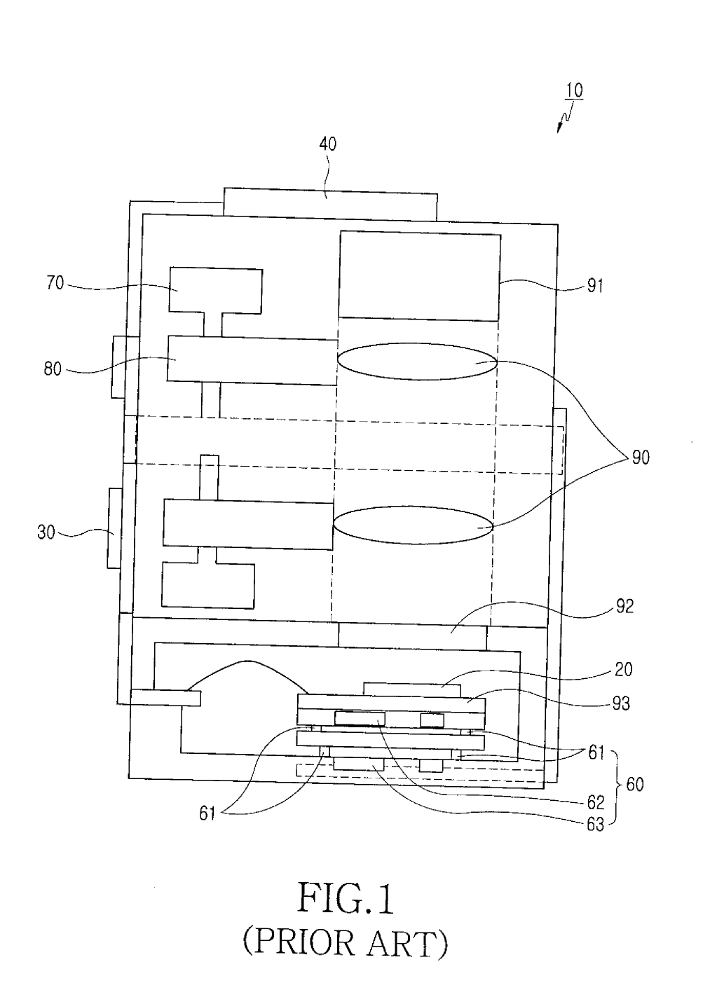

FIG. 2 is a block diagram of the conventional camera module in use;

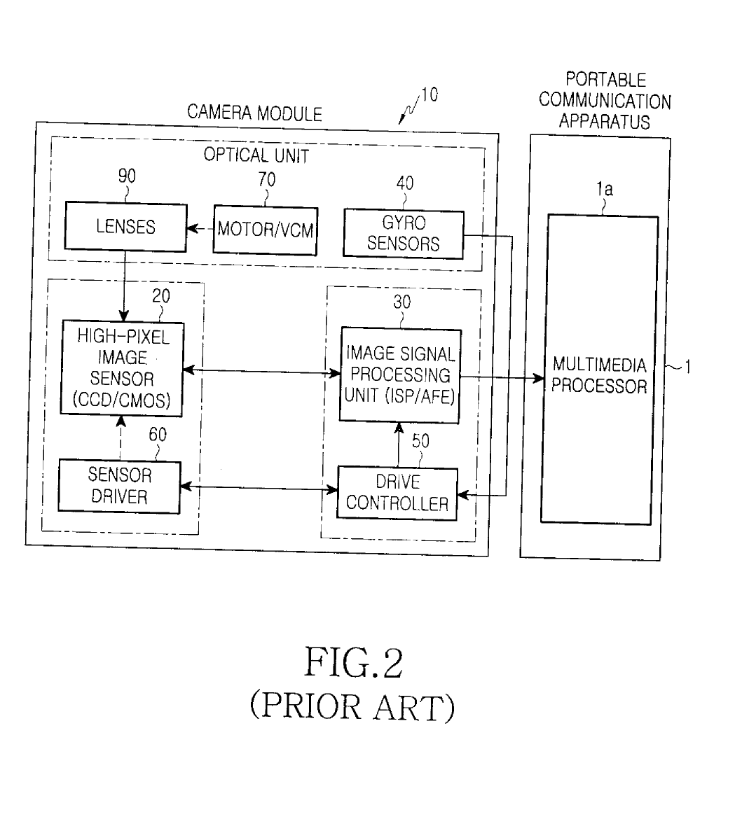

FIG. 3 is a cross-sectional view of a camera module having an image sensor according to an exemplary embodiment of the present invention;

FIG. 4 is a block diagram of the camera module in use according to an exemplary embodiment of the present invention;

FIG. 5 illustrates image data (a vector pattern) captured using the camera module according to an exemplary embodiment of the present invention; and

FIG. 6 illustrates image data (a vector pattern) acquired after the image sensor of the camera module is moved according to an exemplary embodiment of the present invention is changed.

Throughout the drawings, the same drawing reference numerals will be understood to refer to the same elements, features and structures.

### DETAILED DESCRIPTION OF THE INVENTION

The matters defined in the description such as a detailed construction and elements are provided to assist in a comprehensive understanding of an exemplary embodiment of the invention. Accordingly, those of ordinary skill in the art will recognize that various changes and modifications of the embodiment described herein can be made without departing from the scope and spirit of the invention. Also, descriptions of well-known functions and constructions are omitted for clarity and conciseness. Terms used herein are defined based on functions in the present invention and may vary according to users, operators' intention or usual practices. Therefore, the definition of the terms should be made based on contents throughout the specification.

Briefly, the present invention provides inventive correction of hand shakings in two modes: moving image and still image. In the later, it acquires vector-data at four positions and stores the shot four-image data in memory for correction and to obtain a high-pixel image. In acquiring moving image, shots are immediately shot and processed by an image sensor using YUV-data of a moving-image.

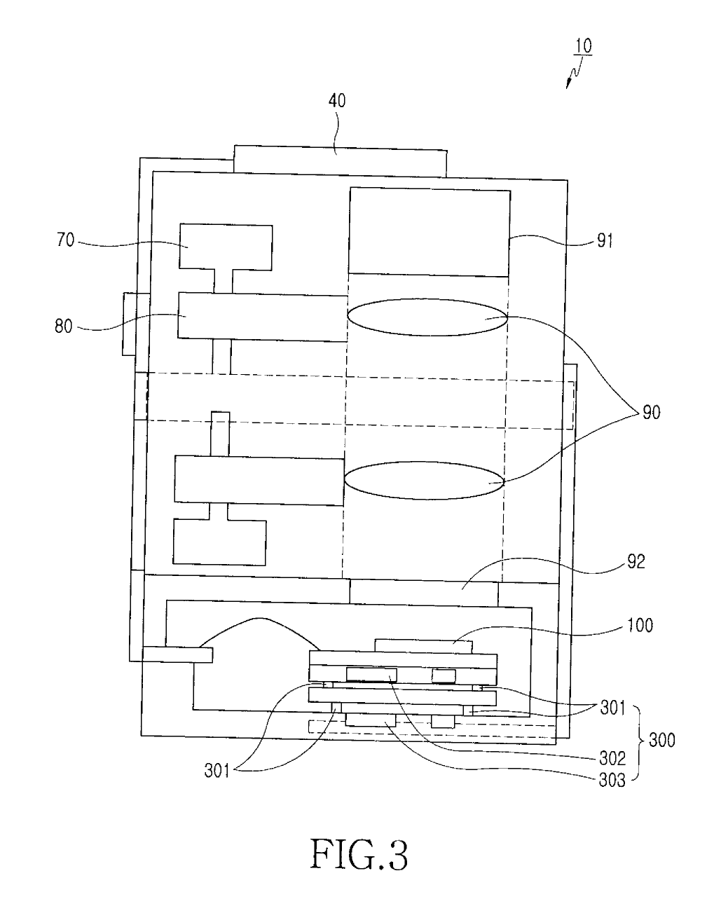

As illustrated in FIG. 3, a camera module 10 having an image sensor according to the teachings of the present invention includes an image sensor unit 100, a drive controller 200, and a sensor driver 300. The image sensor unit 100 converts light being incident after passing through a prism 91 into image data and applies image data, which is hand shake-corrected by the movement between a plurality of position movements, to a multimedia processor 1a of a product. As explained later, the gyrosensors of the present invention detects the amount and direction of the user's hand-shaking, and thus movement between a plurality of position movements corresponds to movements of positions of the gyrosensors. Hence, the hand shake-corrected image data herein refers to an optimal moving image obtained via movement detection by the gyrosensors, which corrects the image shaking due to the hand wobbling. Herein, the product is a portable communication apparatus 1 and may also be a camera-related product such as a digital camera, a digital camcorder, etc.

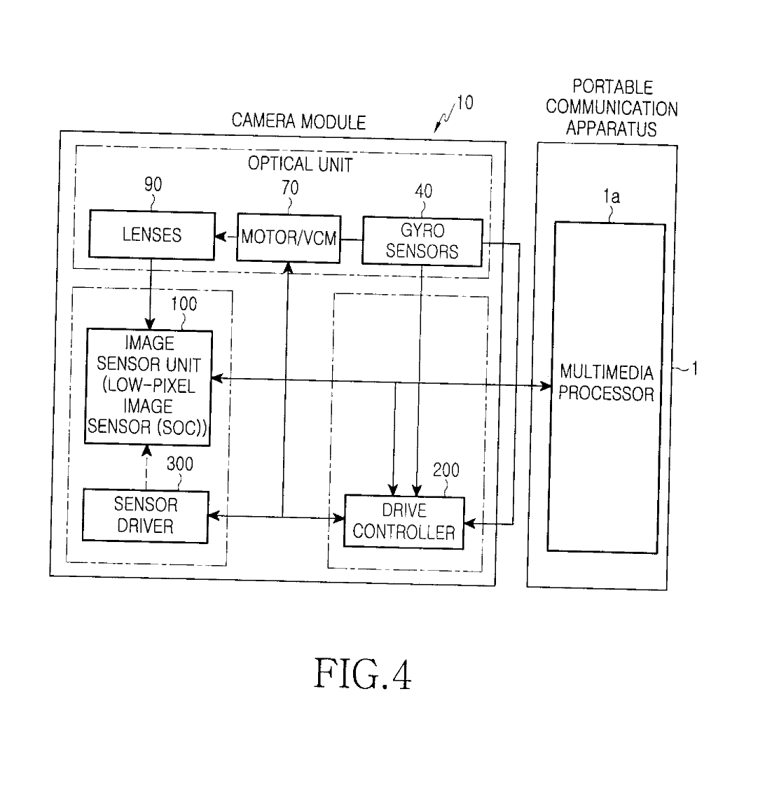

As illustrated in FIGS. 3 and 4, the drive controller 200 receives and calculates hand-shake information acquired by a plurality of gyrosensors 40, and calculates the amount of correction to control the driving of the sensor driver 300, a motor 70, and lenses 90. A plurality of gyrosensors is equipped horizontally and vertically in order to get hand-shake information, i.e., the amount and direction of hand-shaking. The sensor driver 300 moves the image sensor unit 100 for correction under the control of the drive controller 200.

The image sensor unit 100 may include a low-pixel (or low-resolution) image sensor.

The (low-pixel) image sensor unit 100 is integrated with an image signal processing unit such as an Image Signal Processor (ISP).

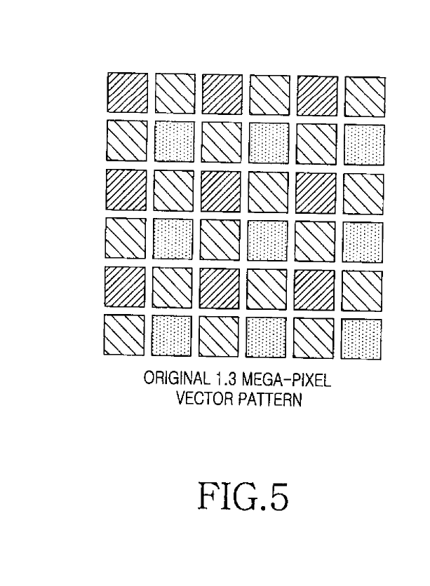

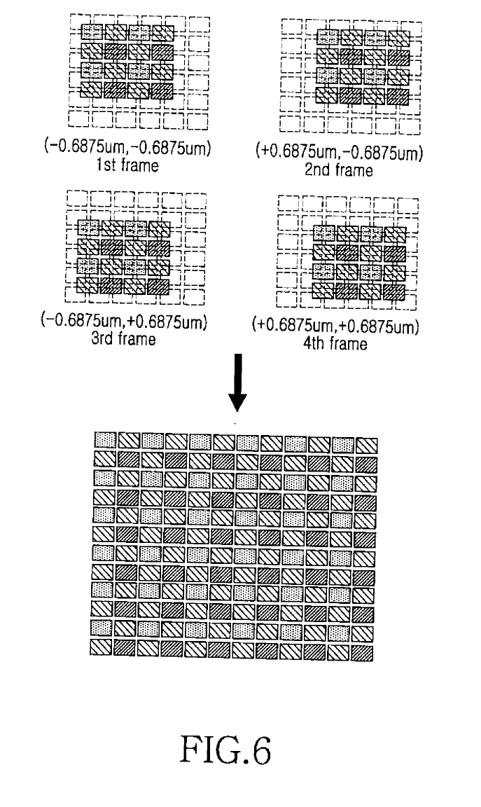

As illustrated in FIGS. 5 and 6, each of the plurality of positions corresponds to ¼ of a pixel size of the image sensor 100.

The image sensor unit 100 is used for the camera module 10 mounted in the portable communication apparatus 1 and is also available for any one of a digital camera and a digital camcorder.

Operations of the camera module 10 having the image sensor unit 100 according to an exemplary embodiment of the present invention will now be described in more detail with reference to FIGS. 4 through 6.

As illustrated in FIG. 3, the camera module 10 includes the low-pixel image sensor unit 100, the drive controller 200, and the sensor driver 300.

As illustrated in FIGS. 3 and 4, when the camera module 10 is used in a moving-image capturing mode, hand-shake information of a hand shake with respect to a center of the lenses 90 of the portable communication apparatus 1 is acquired by the plurality of gyrosensors 40 is applied to the drive controller 200, and the drive controller 200 then calculates the acquired hand-shake information and controls the sensor driver 300 and the motor 70 according to the calculated hand-shake information.

At the same time, the low-pixel image sensor unit 100 outputs corrected image data in a YUV-data format and applies the image data in the YUV-data format to the multimedia processor 1a of the portable communication apparatus 1. The multimedia processor la then processes the image data and displays the processed image data on a display unit, such as Liquid Crystal Display (LCD) unit (not shown), included in the portable communication apparatus 1.

As seen above, the YUV-data of a moving-image capturing mode according to the present invention enables the moving image to be shot and processed by an image sensor immediately.

As illustrated in FIGS. 3 through 6, when the camera module 10 is used in a still-image capturing mode, the sensor driver 300 moves to a first position among four positions with respect to the low-pixel image sensor unit 100 and the drive controller 200 calculates the hand-shake information acquired by the plurality of gyrosensors 40 and controls the sensor driver 300 to correct the hand shake and thus to acquire an image of a maximum resolution, e.g., 1.3 ten thousand pixels, allowed by the low-pixel image sensor 100.

As illustrated in FIGS. 5 and 6, the sensor driver 300 sequentially moves to a second position, a third position, and a fourth position with respect to the low-pixel image sensor unit 100, and acquires images in the positions in the same manner.

As illustrated in FIG. 6, each of the four positions corresponds to ¼ of a pixel size of the low-pixel image sensor unit 100. For example, for a pixel size of 2.75 μm×2.75 μm, the first through fourth positions are (−0.6875 μm, −0.6875 μm), (−0.6875 μm, +0.6875 μm), (+0.6875 μm, −0.6875 μm), and (+0.6875 μm, +0.6875 μm), respectively.

In the still-image capturing mode, unlike in the moving-image capturing mode, the low-pixel image sensor unit 100 outputs image data in a Bayer-data format, and the multimedia processor 1a of the portable communication apparatus 1 stores four pieces of image data in a memory (not shown) of the portable communication apparatus 1 and then interpolates them to generate a high-pixel (or high-resolution) image (1.3 million pixels×4=5.2 million pixels.

The sensor driver 300 includes a plurality of balls 301, a permanent magnet 302, and a coil 303. Once power is supplied to the coil 303, the coil 303 generates a magnetic field together with the permanent magnet 302 to move the permanent magnet 302 by means of the plurality of balls 301. The low-pixel image sensor unit 100 moves together with the permanent magnet 302 in order to compensate hand shaking and also moves along a coil.

As seen above, the present invention provides correction of handshakes during operation without the need for additional parts, such as optical image stablizers and high-pixel sensor, thus enabling product miniaturization and manufacturing cost reduction.

While the camera module having the image sensor according to the present invention has been shown and described with reference to a certain preferred embodiment thereof, it will be understood by those skilled in the art that various changes in form and details may be made therein without departing from the spirit and scope of the invention as defined by the appended claims.

What is claimed is:

1. A camera module having an image sensor, comprising:
an image sensor unit for converting light being incident thereon into an image data, which is hand shake-corrected by movement between a plurality of position movements, to a multimedia processor of a product; and
a drive controller for receiving and calculating hand-shake infonnation acquired by a plurality of gyrosensors and calculating an amount of correction to control a sensor driver and lenses, the sensor driver moving the image sensor unit to correct a hand shake under control of the drive controller.

2. The camera module of claim 1, wherein the image sensor unit comprises a low-pixel image sensor, which includes a System on Chip (SoC).

3. The camera module of claim 1, wherein the image sensor unit is integrated with an image signal processing unit, which includes an Image Signal Processor (ISP).

4. The camera module of claim 1, wherein in a moving-image capturing mode, the image sensor unit acquires the hand-shake information of the hand shake with respect to a center of the lenses, corrects the hand shake, and outputs the hand shake-corrected image data in a YUV-data format to apply the image data in the YUV-data format.

5. The camera module of claim 4, further comprising a multimedia processor to process the image data, and a display unit to display the processed image.

6. The camera module of claim 1, wherein in a still-image capturing mode, the sensor driver sequentially moves to at least four positions with respect to the image sensor unit to correct the hand shake and acquires images of a maximum resolution allowed by the image sensor unit, and the image sensor unit converts the acquired images into image data and outputs the respective image data in a vector-data format.

7. The camera module of claim 6, wherein each of the at least four positions corresponds to ¼ of a pixel size of the image sensor unit.

8. The camera module of claim 6, further comprising a multimedia processor to stores the respective image data in a memory and then interpolates the image data to generate a high-pixel image.

9. The camera module of claim 1, wherein the image sensor unit is provided in any one of a camera module mounted in a portable communication apparatus, a digital camera, and a digital camcorder.

10. A portable communication apparatus having the camera module of claim 1.

11. The apparatus of claim 10, wherein the apparatus is any one of a portable communication apparatus, a digital camera, and a digital camcorder.
